(19) United States
(12) Patent Application Publication
(10) Pub. No.: US 2026/0314532 A1
(43) Pub. Date: Oct. 15, 2026

(54) HARVESTER LIQUID APPLICATION SYSTEM, DEVICES, AND METHODS

(71) Applicant: Ag Leader Technology, Ames, IA (US)

(72) Inventors: Parker Wells, Polk City, IA (US); Tucker Gabriel, Ames, IA (US)

(21) Appl. No.: 19/467,588

(22) Filed: Feb. 2, 2026

Related U.S. Application Data
(60) Provisional application No. 63/572,341, filed on Mar. 31, 2024.

(51) Int. Cl. A01D 43/14; A01D 45/02

(52) U.S. Cl. CPC A01D 43/14; A01D 45/02

(57) ABSTRACT

An agricultural harvester comprising a header comprising a plurality of row units, a stalk sensor on each of the plurality of row units, a sprayer nozzle on each of the plurality of row units in sequence with the stalk sensor. The harvester also comprising a GPS unit configured to determine a travel speed of the agricultural harvester and a controller in communication with each stalk sensor, each sprayer nozzle, wherein a liquid is precisely applied to the field by the sprayer nozzle via commands from the controller based on the travel speed of the agricultural harvester and stalk locations determined by the stalk sensor on a row by row basis.

### CROSS-REFERENCE TO RELATED APPLICATION(S)

This application claims the benefit under 35 U.S.C. § 119(e) to U.S. Provisional Application 63/572,341, filed Jan. 31, 2025, and entitled Harvester Liquid Application System, Devices, and Methods, which is hereby incorporated herein by reference in its entirety for all purposes.

### TECHNICAL FIELD

The disclosure relates to agricultural liquid application and harvest operations.

### BACKGROUND

Typically, farmers complete each farming operation (planting, spraying, on separate passes through a field. For example, currently, the farmer would harvest with a combine and then come back at a different time after harvest to spray the entire field with product to assist in breaking down the remaining crop residue and stalks. This requires time for a second implement pass through the field and well as additional fuel.

### BRIEF SUMMARY

In Example 1, an agricultural harvester comprising a header comprising a plurality of row units, a stalk sensor on each of the plurality of row units, and a sprayer nozzle on each of the plurality of row units in sequence with the stalk sensor. The harvester also comprising a GPS unit configured to determine a travel speed of the agricultural harvester and a controller in communication with each stalk sensor, each sprayer nozzle, wherein a liquid is precisely applied to the field by the sprayer nozzle via commands from the controller based on the travel speed of the agricultural harvester and stalk locations determined by the stalk sensor on a row by row basis.

Example 2 relates to the agricultural harvester of any of Examples 1 and 3-9, wherein the stalk sensor is a mechanical stalk sensor.

Example 3 relates to the agricultural harvester of any of Examples 1-2 and 4-9, wherein the stalk sensor is a light sensor.

Example 4 relates to the agricultural harvester of any of Examples 1-3 and 5-9, wherein the stalk sensor is a camera.

Example 5 relates to the agricultural harvester of any of Examples 1-4 and 6-9, further comprising an artificial intelligence (AI) algorithm configured to identify stalks from images obtained from the camera.

Example 6 relates to the agricultural harvester of any of Examples 1-5 and 7-9, wherein the harvester further comprises a liquid application system comprising one or more tanks.

Example 7 relates to the agricultural harvester of any of Examples 1-6 and 8-9, wherein the sprayer nozzle is a PWM nozzle.

Example 8 relates to the agricultural harvester of any of Examples 1-7 and 9, wherein the liquid is applied to stalks as they pass by the sprayer nozzle.

Example 9 relates to the agricultural harvester of any of Examples 1-8, wherein the liquid is applied between stalks.

In Example 10, a system for application of a fluid during harvest operations comprising a head comprising a stalk sensor disposed on a row unit and a nozzle disposed on the row unit in sequence with the stalk sensor and a controller in communication with the stalk sensor and the nozzle, wherein the nozzle is actuated via commands from the controller based on stalk locations determined by the stalk sensor.

Example 11 relates to the system of any of Examples 10 and 12-19, wherein the controller uses a known offset between the stalk sensor and the nozzle and a travel speed to determine when a stalk will be adjacent to the nozzle after passing the stalk sensor.

Example 12 relates to the system of any of Examples 10-11 and 13-19, wherein the travel speed is obtained from a GPS unit.

Example 13 relates to the system of any of Examples 10-12 and 14-19, wherein the stalk sensor is a mechanical contact sensor.

Example 14 relates to the system of any of Examples 10-13 and 15-19, wherein the stalk sensor is a light sensor.

Example 15 relates to the system of any of Examples 10-14 and 16-19, wherein the stalk sensor is a camera.

Example 16 relates to the system of any of Examples 10-15 and 17-19, further comprising an artificial intelligence (AI) algorithm configured to identify stalks from images obtained from the camera.

Example 17 relates to the system of any of Examples 10-16 and 18-19, wherein the nozzle is actuated such that a liquid is applied to stalks as they pass by the sprayer nozzle.

Example 18 relates to the system of any of Examples 10-17 and 19, wherein the nozzle is actuated such that a liquid is applied between stalks.

Example 19 relates to the system of any of Examples 10-18, wherein the nozzle is a PWM nozzle.

In Example 20, a system for application of a fluid during harvest operation comprising a harvesting head comprising: a plurality of row units; a stalk sensor on each of the plurality of row units; and a sprayer nozzle on each of the plurality of row units in sequence with the stalk sensor, a GPS unit configured to determine a travel speed of the agricultural harvester, and a controller in communication with each stalk sensor, each sprayer nozzle, wherein the fluid is applied to a field by the sprayer nozzle via commands from the controller based on the travel speed of the agricultural harvester and stalk locations determined by the stalk sensor on a row by row basis.

A system of one or more computers or computing devices can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a diagram of a harvester implementing the system, according to one implementation.

FIG. 2 is a system diagram, according to one implementation.

FIG. 3 is an top down view of a harvester row unit, according to one implementation.

FIG. 4 is a side vie of a harvester row unit harvesting stalks, according to one implementation.

FIG. 5A is a top down view of a row unit with the sensor contacting a stalk, according to one implementation.

FIG. 5B is a top down view of a row unit while the sensors are not contacting a stalk, according to one implementation.

FIG. 6 is a diagram of a harvester including a liquid application system, according to one implementation.

### DETAILED DESCRIPTION

Disclosed herein is a system and related devices and methods for application of a liquid/fluid during harvest operations. In various implementations, crop detection devices, such as mechanical wands, light gates, camera systems, or other contact sensors on a harvester head, a GPS unit (or other mechanism for determining heading and speed), and a pulse width modulation (PWM) liquid system either on the vehicle or the harvesting head are used for the application of liquid in the field as the crop is being harvested. The system disclosed herein may be used for application of many different liquids such as but not limited to herbicide, pesticide, or biologicals, optionally to help in the breakdown on stalks.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sept. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. Pat. No. 12,353,210, issued Jul. 8, 2025, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. Pat. No. 12,268,115, issued Apr. 8, 2025, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. Pat. No. 12,414,505, issued Sep. 16, 2025, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/556,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Pat. No. 12,403,950, issued Sep. 2, 2025, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/766,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensors and Related Devices, Systems, and Methods,” U.S. patent application Ser. No. 19/367,363, filed Oct. 23, 2025, entitled “Agricultural Sprayer Sensor and Related Devices, Systems, and Methods,” U.S. patent application Ser. No. 19/390,280, filed Nov. 14, 2025, entitled “Liquid Product Distribution for Agricultural Spraying Systems and Related Devices and Methods,” U.S. patent application Ser. No. 19/396,047, filed Nov. 20, 2025, entitled “Agricultural Harvesting Systems and Related Devices and Methods,” U.S. patent application Ser. No. 19/396,099, filed Nov. 20, 2025, entitled “Sprayer Nozzle Devices and Related Systems and Methods,” U.S. patent application Ser. No. 19/397,422, filed Nov. 21, 2025, entitled “Systems, Methods, and Devices for Increasing Machine Operating Range,” U.S. patent application Ser. No. 19/408,177, filed Dec. 3, 2025, entitled “Agricultural Guidance and Navigation System and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” U.S. Patent Application 63/906,692, filed Oct. 28, 2025, entitled “Agricultural Alignment System and Related Devices and Methods,” U.S. Patent Application 63/906,646, filed Oct. 28, 2025, entitled “Automated Grail Filling System and Related Devices and Methods,” U.S. Patent Application 63/967,084, filed Jan. 23, 2025, entitled “System and Methods of Row-by-Row Yield Monitoring,” U.S. Patent Application 63/966,976, filed Jan. 23, 2025, entitled “Dispatch Indicator Calibration,” and U.S. Patent Application 63/967,038, filed Jan. 23, 2025, entitled “Grain Fill Sensor and Related Devices, Systems, and Methods,” each of which is incorporated herein by reference.

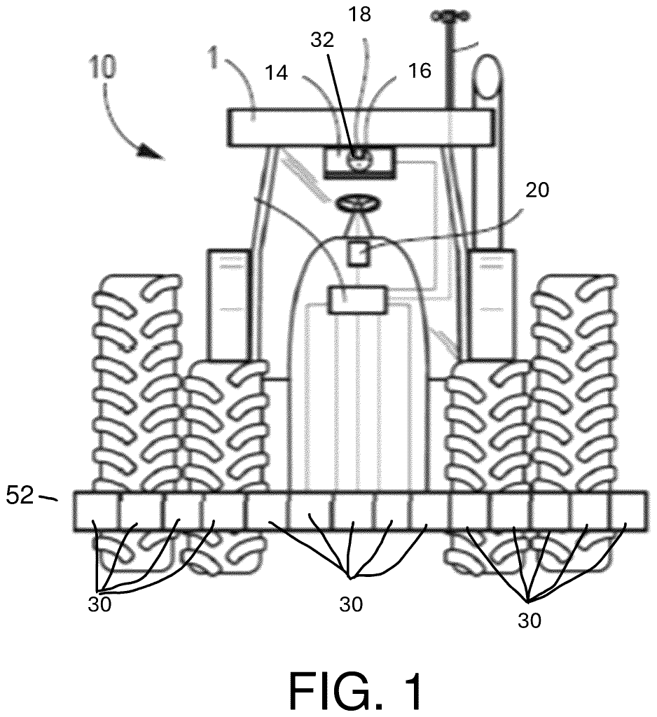

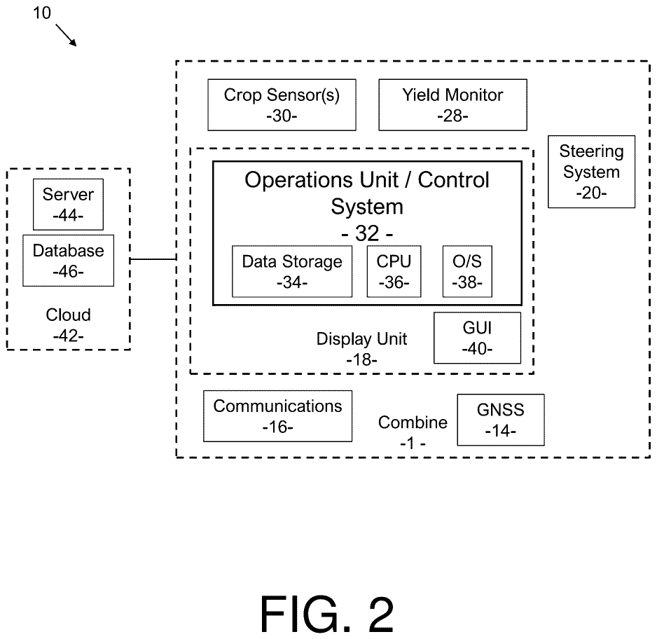

Turning to the figures in more detail, in various implementations the integrated liquid application system 10 is implemented on a combine 1 or similar vehicle 1, as would be understood, shown in FIG. 1. In various implementations, the system 10 includes a GNSS or GPS receiver 14, one or more crop sensors 30 in operational communication with a vehicle system display 18, such as the InCommand® display from Ag Leader®, and an operations unit 32, as is shown in greater detail in FIG. 2. The system 10 optionally comprises various additional sensors, monitors and the like, as would be appreciated by those of skill in the art and as disclosed in various of the incorporated references.

The system 10 further includes an automatic and/or assisted steering system 20. As would be understood, various automatic and/or assisted steering systems 20 are configured to take inputs from an operations unit 32 navigate a vehicle through a field. Various steering systems 20 may manually and/or electronically manipulate the systems on board a harvest vehicle 1 to effectuate automatic and/or assisted steering, as would be appreciated by those of skill in the art. In various implementations, the automatic / assisted steering system 20 allows for autonomous navigation.

Continuing with FIGS. 1 and 2, in various implementations, the system 10 includes an operations unit 32, optionally integrated within the display, in operational communication with data link 16 (also referred to herein as a communications component 16). It is generally understood that these components may optionally be housed within the display unit 18 and that the representation of FIG. 2 is merely exemplary.

In certain implementations, the operations unit 32 is also configured for the sending and receiving of data for storage and processing, such as to the cloud 42, a remote server 44, database 46, and/or other cloud computing components readily understood in the art. Such connections by the operations unit 32, can be made wirelessly via understood internet and/or cellular technologies such as Bluetooth, Wi-Fi, LTE, 3G, 4G, or 5G connections, and the like. It is understood that in certain implementations, the operations unit 32 and/or cloud 42 component may comprise encryption or other data privacy components such as hardware, software, and/or firmware security aspects.

Continuing with FIG. 2, the operations unit 32, according to certain implementations, further has one or more optional processing and computing components, such as data storage 34, a CPU or processor 36, an operating system (“O/S”) 38, and other computing components necessary for implementing the various technologies disclosed herein. It is appreciated that the various optional system components are in operational communication with one another via wired or wireless connections and are configured to perform the processes and execute the commands described herein. As would be understood, each of these components can be located optionally at various locations around the vehicle or elsewhere, such as in the cloud 42 and accessible by a wireless or cellular connection.

In various implementations, this connectivity means that an operator, enterprise manager, and/or other third party is able to receive notifications such as adjustment prompts and confirmation screens on their mobile devices or via another access point. In certain implementations, these individuals can review the various data collected or recorded by the system 10 and make adjustments, comments, and/or observations in real-time or near real-time, as would be readily appreciated.

As shown in FIGS. 1 and 2, the system 10 includes at least one crop sensor 30 that is in operational communication with the system 10 and operations unit 32 via the communications component or data link 16. It is understood that in certain implementations, the crop sensor(s) 30 are in direct operational communication with the operations unit 32 and/or steering system 20, and that it is calibrated to utilize raw data values generated by those crop sensors 30 to perform various tasks as will be discussed in further detailed herein. Various exemplary crop sensors 30 are discussed in various of the incorporated references including: U.S. Pat. Nos. 11,064,653, 11,297,768, U.S. patent application Ser. No. 17/226,002, U.S. patent application Ser. No. 17,013,037, and U.S. patent application Ser. No. 18/087,413 among others.

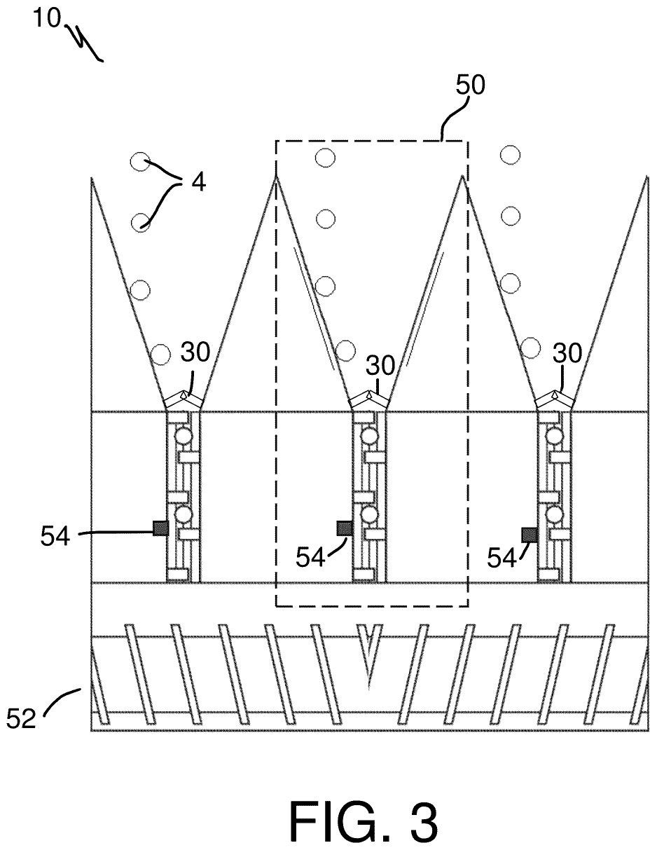

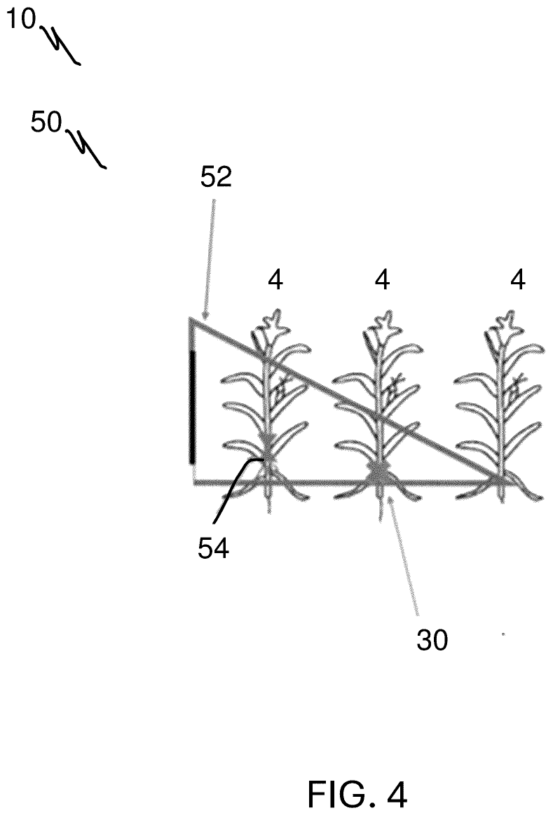

In various implementations, the wands 30 or other crop sensors 30 are mounted on the head 52 in a fixed location. These sensors 30 are configured to detect when a stalk 4 goes through the row unit (show at outline 50) of the head 52, shown in FIGS. 3 and 4. The control system 32, optionally integrated into a display 18, knows offset of wands 30 to a pulse width modulation (PWM) coil/nozzle 54. The offset may be stored in data storage 34 and may be user entered. The control system 32 also determines the speed of travel of the vehicle 1, optionally derived from the GPS 14 or other mechanism such as a speedometer. With the known offset and speed of the vehicle 1, the system 10 can determine when the PWM coil 54 will reach the stalk 4 after encountering the stalk sensors 30. The system 10 may then actuate the PWM coil 54 to apply a liquid directly to the stalk 4 and/or between stalks 4. Optionally, the system 10 may control liquid application on a row-by-row (R×R) basis, as stalks 4 may not be in the same location across the head 52.

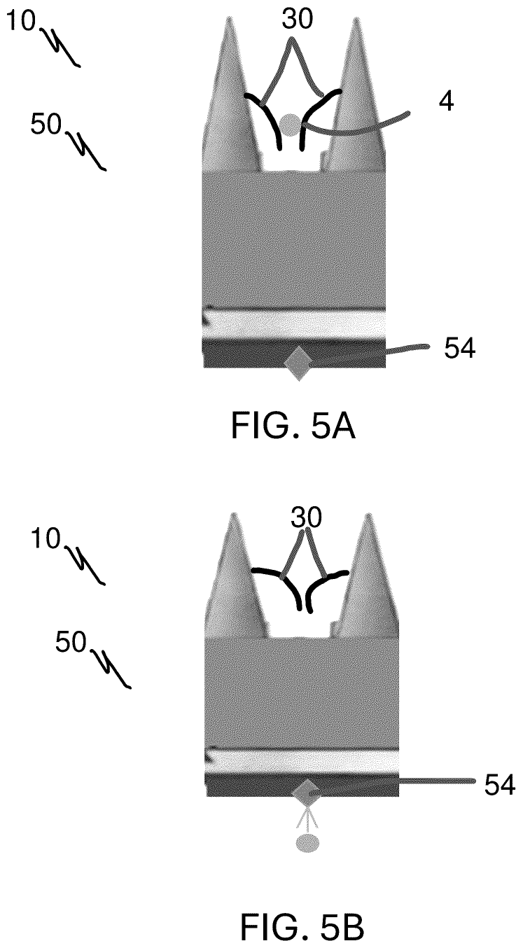

As shown for example in FIGS. 5A and 5B, when the stalk 4 is being contacted by the sensors 30 the PWM coil is off (FIG. 5A) and when the stalk 4 is no longer in contact with the sensors 30 the PWM coil is on (FIG. 5B).

In various implementations, an artificial intelligence (AI) algorithm or other machine learning technique may be employed by the system to determine stalk locations. In one example, where the row unit 50 includes be a row camera (optionally as the stalk sensor 30) to visually recognize a stalk 4, the an AI system may “mark” a location for the where the stalk is and could be taught with pictures and videos what these stalks looks like versus what weeds look like in the row, such that only stalks are detected and weeds that may activate a contact sensor would not be confused for a stalk leading to a possible misapplication of the fluid.

In another example, an AI system could se a combination of data acquired from prior operations (e.g. a seed sensor during planting) and a camera 30 to determine if each seed grew into a stalk after planting or not. If the seed grew into a stalk, and the system is configured for spraying stalks directly, the nozzle may be actuated to spray the stalk.

The system 10 allows farmers to complete two actions, harvesting and liquid application, in one pass of a machine 1, such as a harvester 2. That is, the system 10 allows for harvest operations, as well as application of liquid at the same time. Depending on the liquid applied, the system 10 may also aid in the breakdown of crop residue in the field, which reduces the need for conventional tillage which is typically used to incorporate the crop residue into the soil to speed up the breakdown process.

The system 10 may allow for more efficient application of liquid to the field by reducing the amount of product that farmers will need to properly apply over a field because of the targeted application. Additionally, the system 10 will limit refill time, and lead to more efficient harvesting/application. Reduction in product, as well as completing the application with 1 the combine makes the application cheaper for farmers by saving on time, fuel, engine hours, etc.

Additionally, liquid application at the time of harvest gives the products time to start working immediately rather than if they were applied at the end of the season, increasing their effectiveness before debris blows away or new weed seeds have a chance to germinate. Still further, for biological products, applying by head 52 and then allowing debris to cover the application would protect the microbes from direct sunlight and help retain moisture, both of which may make the biologic more effective.

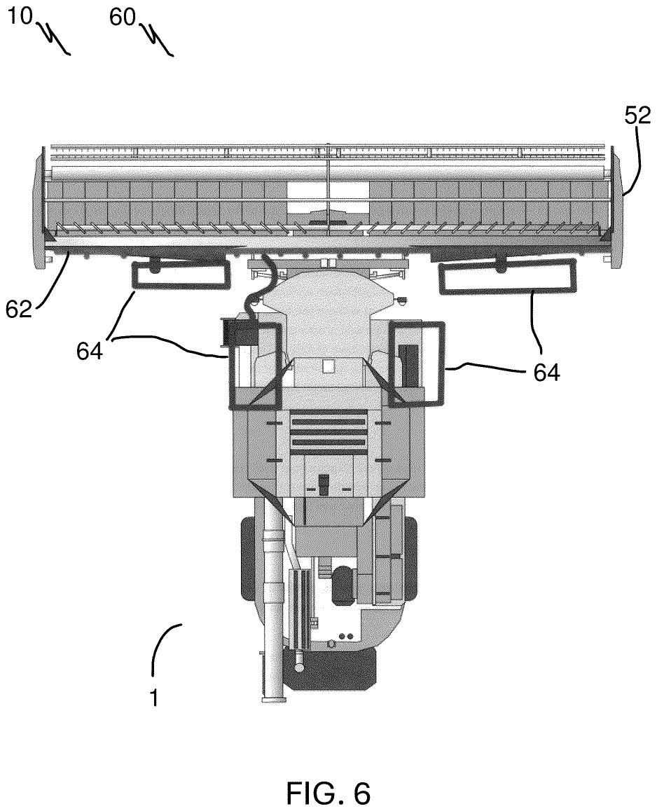

In various implementations, shown for example in FIG. 6, a compact liquid application system 60 is retrofitted to a harvester vehicle 1 and/or header unit 52 to allow spraying at harvest without the need for an additional field pass, optionally using the disclosed system 10. The compact liquid application system 60 may apply various products including herbicides and biological products, among other as would be understood, that would be typically applied after harvest to protect against weeds and aid in the breakdown of debris. The system 60 may mount entirely to harvester 1 chassis, a header 52, or a combination of both. The system 60 may include a number of components common to agricultural sprayers, including hoses 62, tanks 64, pumps, valves, nozzles, etc. as would be appreciated by those of skill in the art.

Although the disclosure has been described with references to various embodiments, persons skilled in the art will recognize that changes may be made in form and detail without departing from the spirit and scope of this disclosure.

What is claimed is:

1. An agricultural harvester comprising:
(a) a header comprising:
(i) a plurality of row units;
(ii) a stalk sensor on each of the plurality of row units; and
(iii) a sprayer nozzle on each of the plurality of row units in sequence with the stalk sensor;
(b) a GPS unit configured to determine a travel speed of the agricultural harvester; and
(c) a controller in communication with each stalk sensor, each sprayer nozzle,
wherein a liquid is precisely applied to the field by the sprayer nozzle via commands from the controller based on the travel speed of the agricultural harvester and stalk locations determined by the stalk sensor on a row by row basis.

2. The agricultural harvester of claim 1, wherein the stalk sensor is a mechanical stalk sensor.

3. The agricultural harvester of claim 1, wherein the stalk sensor is a light sensor.

4. The agricultural harvester of claim 1, wherein the stalk sensor is a camera.

5. The agricultural harvester of claim 4, further comprising an artificial intelligence (AI) algorithm configured to identify stalks from images obtained from the camera.

6. The agricultural harvester of claim 1, wherein the harvester further comprises a liquid application system comprising one or more tanks.

7. The agricultural harvester of claim 1, wherein the sprayer nozzle is a PWM nozzle.

8. The agricultural harvester of claim 1, wherein the liquid is applied to stalks as they pass by the sprayer nozzle.

9. The agricultural harvester of claim 1, wherein the liquid is applied between stalks.

10. A system for application of a fluid during harvest operations comprising:
(a) a head comprising:
(i) a stalk sensor disposed on a row unit; and
(ii) a nozzle disposed on the row unit in sequence with the stalk sensor; and
(b) a controller in communication with the stalk sensor and the nozzle, wherein the nozzle is actuated via commands from the controller based on stalk locations determined by the stalk sensor.

11. The system of claim 10, wherein the controller uses a known offset between the stalk sensor and the nozzle and a travel speed to determine when a stalk will be adjacent to the nozzle after passing the stalk sensor.

12. The system of claim 11, wherein the travel speed is obtained from a GPS unit.

13. The system of claim 10, wherein the stalk sensor is a mechanical contact sensor.

14. The system of claim 10, wherein the stalk sensor is a light sensor.

15. The system of claim 10, wherein the stalk sensor is a camera.

16. The system of claim 15, further comprising an artificial intelligence (AI) algorithm configured to identify stalks from images obtained from the camera.

17. The system of claim 10, wherein the nozzle is actuated such that a liquid is applied to stalks as they pass by the sprayer nozzle.

18. The system of claim 10, wherein the nozzle is actuated such that a liquid is applied between stalks.

19. The system of claim 10, wherein the nozzle is a PWM nozzle.

20. A system for application of a fluid during harvest operation comprising:
(a) a harvesting head comprising:
(i) a plurality of row units;
(ii) a stalk sensor on each of the plurality of row units; and
(iii) a sprayer nozzle on each of the plurality of row units in sequence with the stalk sensor;
(b) a GPS unit configured to determine a travel speed of the agricultural harvester; and
(c) a controller in communication with each stalk sensor, each sprayer nozzle,
wherein the fluid is applied to a field by the sprayer nozzle via commands from the controller based on the travel speed of the agricultural harvester and stalk locations determined by the stalk sensor on a row by row basis.
